(19) United States
(12) Patent Application Publication
(10) Pub. No.: US 2003/0130113 A1
(43) Pub. Date: Jul. 10, 2003

(54) Liquid catalyst

(76) Inventors: Eduard Schmid, Bonaduz (CH); Ivano Laudonia, Thusis (CH); Eveline Kunzi, Chur (CH)

Correspondence Address: MARSHALL & MELHORN, FOUR SEAGATE, EIGHT FLOOR, TOLEDO, OH, 43604, US

(21) Appl. No.: 10/172,341

(22) Filed: Jun. 14, 2002

(30) Foreign Application Priority Data
Jun. 15, 2001 (DE) 101 29 049.7

(51) Int. Cl. B01J 31/00

(52) U.S. Cl. 502/167; 502/150; 502/162

(57) ABSTRACT

The invention relates to liquid catalysts for implementation of anionic lactam polymerization, containing a conversion product of lactam, isocyanate and a base, the conversion product being dissolved in a solvation medium, and also a method for the production thereof. These catalysts are used for direct production of granulate or utility objects made of polylactam.

The invention relates to liquid catalysts (FK) for the activated anionic polymerization of lactams.

Liquid catalysts for the anionic lactam polymerization are known.

Systems which have a long shelf life are described in DE 196 02 683 C1 and in DE 196 02 684 C1, said systems containing both the catalyst, activator and additives. A similar system is presented also in DE 196 03 305 C2.

In order to produce these systems, an activator for the polymerization ol lactam, such as for example a carbodiimide is dissolved in an aproti4c solvent, such for example N-alkylated acid amide or N-alkylated urea derivative, and then is converted with the normal catalyst for the anionic lactam polymerization.

These catalysts comprise in general sodium caprolactamate dissolved in approximately four mol parts caprolactam. These systems hence contain up to 80% by weight of unconverted lactam. Since, when the activator and catalyst for the lactam polymerization are combined in the solvent, the conditions are created for the lactam polymerization, the proportion of free lactam contained in the catalyst can slowly undergo the anionic lactam polymerization even at storage temperature (for example 20-50°C.), as a result of which in particular the viscosity of the catalyst solution increases. Such catalysts must also be applied in a relatively high weight proportion of for example 3-10%.

In order to overcome this disadvantage, a method for producing liquid catalysts is described in DE 197 15 679 C2, in which method the catalyst, essentially alkali lactamate, is produced directly in an aprotic salvation medium and then converted with an activator for the lactam polymerization. In particular carbodiimides and also capped diisocyanates are thereby proposed as activators.

As can be deduced from the examples of the above-mentioned patent document, these systems lead predominantly however to very “slow” polymerization behaviour. In order to characterize the polymerization behaviour, the so-called gelling time t, is ascertained, from which the viscosity of the melt increases massively. This tu time, measured at 200°, is thereby in the range of minutes for lactam-12 for the liquid catalysts used in the above-mentioned patent when using carbodiimide as activator. Such catalyst systems are hence suitable for applications in which the polymerization is intended specifically to proceed slowly. Of concern hereby is for example the impregnation of fibre structures with the formation of fibre composite materials when the polymerization of the lactam is completed or the wetting of fillers in the monomer moulding process for the purpose of improving dimensional stability.

It can be deduced from the disclosure content of the above-mentioned patent document (Table 2 and 4) that, in the systems in which special isocyanates, namely capped diisocyanates (system IL-6 and lox) are used as activator, this leads to a relatively fast conversion. However it is disadvantageous hereby that these lead to insoluble, cross-linked polylactams which are no longer workable and hence are no longer suitable for the thermoplastic processing processes.

In addition to moulding processes, also continuous lactam polymerization in a twin screw extruder, for example a ZSK-30, has recently become known and is described in S. K. Ha, J. L. White: Continuous Polymerization of Lauryl Lactam to PA 12, Intern. Polymer Processing XIII (1998) 2, Hanser Publishers, Munich. Lactam-12 is thereby premixed separately with commercially available sodium caprolactamate as catalyst and N-acetyl caprolactam as initiator. The conditions of the polymerization with this system are illustrated comprehensively in the mentioned publication and at best there is achieved a lactam conversion of just 98% with a low throughput of only 2 kg/h and a dwell time of several minutes.

Proceeding from DE 197 15 679 C2, it is the object of the present invention to find a rapid catalyst system occurring in a liquid form which leads to a conversion of lactam of more than 99%, whereby thermoplastically processible polylactams are obtained. It is furthermore the object of the invention to indicate a corresponding production method.

The invention is achieved by the features of claim 1 with respect to the catalyst system and by the features of claim 20 with respect to the method. The sub-claims indicate preferred embodiments.

It has now been surprisingly shown that special liquid catalysts (FK) are able to initiate the polymerization of lactam (LC) in an extraordinarily rapid manner and that the total polymerization time in a commonly used extruder, for example a ZSK-30 or a ZSK-25 (both extruders by Werner Pfleiderer, Stuttgart, as used in the case of S. K. Ha) is in the range of 30-200 seconds (with suitable twin-screws), and a lactam conversion into polylactam of at least 99% by weight being achieved.

It is essential that, when using the liquid catalysts according to the invention, thermoplastically processible polylactam is obtained respectively.

The choice of the isocyanates is thereby essential to the invention in the case of the catalyst. According to the invention, exclusively phenylisocyanate (PIC), substituted phenylisocyanate and cyclohexylisocyanate (Cy) or mixtures thereof are used as isocyanate (IC). In the case of the substituted variants, those with alkyl or halogen substitutes are preferred. The isocyanates can also occur in cyclized structures (for example as trimers), (for example tripheny-lisocyanurate).

These liquid catalysts are hence based on specifically selected isocyanate (IC), converted to at least 50% with a lactam (LC), the conversion product being deprotonated with a strong base (B) under selected conditions, and the resultant salt occurring dissolved in an aprotic salvation medium (S).

These liquid catalysts (FK) which have at most a low lactam excess from the synthesis, have a long shelf life and, when added in a small weight proportion to the lactam melt, initiate polymerization of the lactam (LC) in an unusually rapid manner so that, dependent upon the temperature, a lactam conversion of above 99% is achieved even after a short time.

The use of such catalysts offers in practice many advantages, such as:

Polymerization is directly initiated starting from a pure lactam melt of a long shelf life by adding a homogenous liquid in a small weight proportion.

In particular this catalyst can be continuously metered directly into the lactam melt which is already under mixing conditions in the extruder. Hence the polymerization process can be started in an exceptionally simple manner.

Whilst the known activators that rapidly initiate polymerization of lactam, such as isocyanates and in particular phenylisocyanate, are volatile and exceptionally toxic compounds, the isocyanate in the case of the liquid catalyst according to the invention is already “capped” with a lactam and deprotonated by the help of a strong base, so that a negatively charged and no longer volatile particle occurs, said particle occurring in particular in the form of its alkali salt and being dissolved in a salvation medium. Hence toxicity and environmental hazard are extensively excluded.

The concept of direct addition of such rapid liquid catalysts containing simultaneous function of catalyst and activator, directly into the lactam melt which is already subject to a mixing effect, while the polymerization being directly initiated and proceeding, simplifies the methods of the continuous lactam polymerization in an exceptional manner and allows entirely new method variants.

A thermoplastically processible polylactam is obtained.

The fact that the liquid catalyst with these selected specific isocyanates has superior properties as shown above, was not to be expected in the knowledge of DE 197 15 679 C2. A person skilled in the art would presumably have assumed from the above-mentioned patent document that the systems with isocyanates, as are described therein in a very general fashion, are suitable for slower reactions, such as for example for impregnation of fibre structures or for wetting fillers in the monomer casting process.

Since the “rapid systems” disclosed in DE 197 15 679 C2 are based exclusively on specific capped diisocyanates and hence led to insoluble cross-linked poly-lactam, a person skilled in the art could in no way deduce therefrom that specifically selected isocyanates, as presented above, have surprising properties.

In particular, completely N-alkylated linear and cyclic carboxamides and ureas, such as for example N-alkyl pyrrolidone and N-alkyl caprolactam or the cyclic N-alkylated ethylene and propylene ureas are suitable as solvents or salvation media (S) which are also well suited as synthesis medium for producing the liquid catalysts.

It is essential that the salvation media (S) are completely aprotic. Further possible salvation media are cited in DE 196 03 305 C2.

Mixtures of solvation media can also be used. P Acid amides are listed in DE 196 02 683 C1 and ureas are listed in DE 196 02 684 C1.

All the compounds which, in the case of a suitable guidance of the chemical reaction, are able to deprotonate lactams and carboxamides or to deprotonate already capped isocyanates (for example capped with lactam) at the nitrogen from —NH— to —N⁻— are suitable as base (B).

For example Na-alcoholate, in particular Na-methy-late, or amide, for example Na-amide, or alkylanion for example butyllithium, or also alkali and alkaline earth in elementary metallic form, in particular sodium metal, and also metal hydrides are suitable as base (with counterion M⁺ generally alkali- and alkaline earth metal ions).

Lactams with 5 to 13 ring members and mixtures thereof, in particular caprolactam and laurinlactam are suitable as lactams (LC).

In order that the lactam polymerization is initiated and proceeds rapidly by means of the catalysts according to the invention, advantageously at least 50% mol of the isocyanate must be capped with lactam and be deprotonated.

If however one wants to let the polymerization be controlled and to proceed in a targeted manner, then additionally selected capping agents (V) of up to maximum 49% mol can be used in the synthesis. Examples are in particular alcohols, such as for example methanol and also linear acid amides.

In the case of acid amides, substances which later can take over an additional task in the polymer are of particular interest, to protect for example the polylactam against weathering- (UV), moisture- and heat action. A corresponding suitable compound is for example the amidic stabilizer Nylostab S-EED of the Clariant company.

The catalyst according to the invention, without the salvation medium (S), has essentially the following general basic structure I, oligomeric, cyclic structures occurring also in accompaniment, the presence of which however does not substantially impair the rate of the lactam conversion.

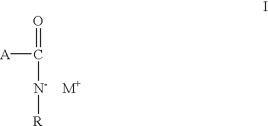

A is thereby the lactam structure on the C corresponding to

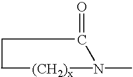

with x=4-11, wherein up to 49% mol of A can be derived from (replaced with) an alternative capping agent (V) for isocyanate, such as alcohol or carbox-amide, methanol (methylate) and linear acid amide being pre-eminent. In particular an acid amide which can in addition exert a stabilizing effect for the polylactam is suitable as linear acid amide, such as for example the amidic polyamide stabilizer Nylostab S-EED by Clariant.

The synthesis of the liquid catalyst according to the invention is advantageously effected directly in the aprotic solvation medium (S) in which the liquid catalyst (FK) subsequently remains dissolved.

The salvation medium (S) to be used is thereby advantageously adapted to the selected synthesis path and the used isocyanate (IC) and lactam (LC). It can thereby be necessary to use mixtures of salvation media according to the invention.

There are various synthesis pathways available for producing the catalysts. In all cases, water-free substances must however be used, and in addition it is best to operate in a dry inert gas atmosphere. The syntheses are implemented in the temperature range of room temperature to 150° C.

Synthesis can proceed for example as follows:

a) Lactam (LC) and if necessary other capping agents (V), such as for example linear acid amide or alcohol, are dissolved in the solvation medium (S). After that, during agitation and suitable temperature control the base (B) is added and, in general under a vacuum, the lactam and if being there the further capping agent is deprotonated. After that, the isocyanate (IC) is added slowly at a suitable temperature, said isocyanate reacting with the deprotonated capping agents, and the liquid catalyst (FK) being produced.

A normal reaction takes place for example in such a manner that N-octylpyrrolidone is chosen as salvation medium, the lactam, for example lactam-6, in a molar proportion of for example 60-100% relative to the isocyanate is dissolved therein and then, with suitable temperature control and under a vacuum, the lactam is deprotonated into lactamate, for which the base Na-methylate is used in a proportion of 1 mol methylate per mol isocyanate. The lactam is thereby completely deprotonated, and the available excess methylate acts directly as additional capping agent.

Next to each other there are thereby produced the two basic structures of the liquid catalyst (FK) according to the invention corresponding to the general formula I:

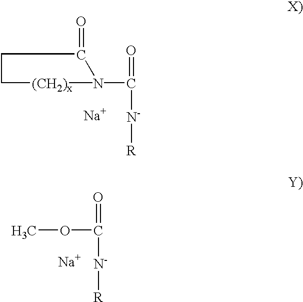

b) One can however also proceed in such a manner that capped isocyanate is used directly as starter material, this is dissolved in the salvation medium and after that the conversion to the lquid catalyst is implemented by the action of the base and suitable temperature control and if necessary under a vacuum.

c) A further synthesis pathway which can be used is that the isocyanate, for example phenylisocyanate, is dissolved in the salvation medium and after that a small quantity of base, such as for example sodium methylate is added, as a result of which the trlmerization reaction of the isocyanate to the (cyclic) isocyanurate is initiated which often proceeds with strong heat of reaction. In order thereby to prevent strong heat release one can alternatively dissolve some base in the salvation medium and then slowly drop in the isocyanate, the cyclization reaction proceeding slowly with a small heat release and being able to stop the reaction at any time. Of course, commercially available isocyanurates can also be used directly.

After that, the lactam and if necessary further protic compounds (capping agents), such as for example linear carboxamide, can be added to the dissolved isocyanurate and subsequently the lactam and if used the further capping agents are deprotonated under temperature control and a vacuum, and are thereby converted with the isocyanurate into the liquid catalyst.

If one uses sodium methylate dissolved in methanol, which is common in the art, then an effective vacuum action is always necessary, and care should be taken to remove the methanol entirely. When using elementary alkali metal as base or when using a strong base, such as for example sodiuym hydride, which leads to volatile reaction products, a vacuum is of course not necessary.

During the conversion process, preferably the following mol ratio is maintained:

(IC):(B):(LC)

(1):(0.8-1.2):(0.8-1.2)

In the case where additional capping agent (V) is used, the following mol ratio is preferred:

(IC):(B):(V):(LC)

(1):(0.9-1.1):(0.49-0.01):(0.51-1.2) particularly preferred is:

(1):(1.1-0.9):(0.1-0.01):(0.9-1.2)

During synthesis of the liquid catalyst according to the invention, an approximately 1:1:1 stoichiometry of lactam and capping agent to the base and to the —N═C═O group in the isocyanate is advantageously maintained. According to the salvation medium selected, the components can be applied respectively also in a restricted excess, for instance the following applying:

In the case of an excess of lactam, this adds directly to a liquid catalyst particle, the primary added lactam experiencing a ring opening.

Excess base, for example sodium methylate, is soluble in a low proportion in many salvation media.

The normal aliphatic isocyanates trimerize spontaneously in the existing basic pH range and thereby lose their volatility and extensively their toxicity.

In exceptional cases, a precipitate can remain in a small quantity after the production of the liquid catalyst. This can occur for example as a consequence of inadequately maintained moisture exclusion or too large a stoichiometry deviation or unsuitable reaction control.

It is then necessary to separate the liquid catalyst from the precipitate. The now present catalyst possesses thereafter the normal activity.

The liquid catalyst according to the invention is used preferably for the continuous polymerization process of LC-12(lauriniactam), for example in an extruder, in particular a twin screw extruder with forced conveying.

In contrast to the catalyst-activator system according to the publication cited at the beginning (S. K. Ha) and also to the liquid catalyst according to DE 197 15 679 C2, polymerization with the liquid catalyst according to the invention proceeds exceptionally rapidly, according to the selected temperature within for example 30-100 seconds, in general polyamide 12 with a lactam-12 residual content of less than 1 and in particular less than 0.5% by weight being produced.

The method is implemented preferably such that further process steps are added directly to the polymerization. For example, subsequent to the polymerization, with an ethylene acrylic acid copolymer, which can also be partly neutralized and can contain further comonomers, the activity of the catalyst can be deactivated and then any type of formulation supplements for an application product, such as for example stabilizers, colourants and pigments, softeners, impact resistant agents, glass and carbon fibres, flame retardants and minerals alone or in suitable combination with each other, can be compounded into the formed molten polylactam, the compound can be discharged as a strand, be cooled, granulated and dried, after which a granulate which is suitable for thermoplastic processing into an application product results.

The liquid catalyst according to the invention is also furthermore well suited for polymerization of lactam-6 (caprolactam), the polymerization proceeding rapidly even at a low temperature of for example 140° C., solid polycaprolactam being produced directly with a low residual monomer content.

At a low polymerization temperature, for example 70-170° C., also moulding processes, for example monomer casting or the rotational moulding process can be successfully carried out in the case of lactam-6, also combined with wetting of reinforcing fibres and mineral and combinations thereof.

The liquid catalyst system according to the invention is suitable as described in particular for polyamide 6 (PA 6) especially in the case where for example utility objects are intended to be produced directly in the finished geometric configuration. This is possible due to the fact that because of the relatively low melting point of lactam-6 (69° C.) it is possible to carry out monomer casting of the liquid lactam at very low temperatures (far below the PA 6 melting point of 222° C.) and moreover because the very rapid liquid catalyst according to the invention still leads even at low temperatures to an adequately fast polymerization. It should be particularly mentioned hereby that, as was established experimentally using a liquid catalyst according to the invention, an LC-6 residual content of below 1% was set already after a few minutes at a polymerization temperature of up to approximately 170° C. It should be mentioned furthermore that the low processing temperature in addition saves energy.

The low residual monomer content is particularly noteworthy since it is known indeed from the state of the art (for example EP 0 137 884) that an equilibrium extract portion of approximately 10% is always set during the polyamide 6 production from caprolactam at approximately 275° C. (therefrom approximately ⅔ lactam monomer), whilst polyamide should have an extract content of below 1 to 2% for practical applications.

These disadvantages can be avoided with the system according to the invention and hence utility objects in the finished geometric configuration can be produced directly in PA 6, the extract content of which fulfils the requirements. It is even possible to mould small tablets in this manner with suitable devices instead of utility objects and to harden these on a band heater or in a fluid bed (at up to approximately 170° C.) in order to obtain a PA 6 granulate which, in contrast to the state of the art (EP 0 137 884), need be neither extracted nor demonomerized.

Via the polymerization of LC-12 directly in a twin screw extruder with subsequent catalyst de-activation and then compounding with additives, granulates are directly accessible which are resistant to decomposition in thermoplastic processes, such as for example extrusion, injection moulding and blow moulding into application products, such as fuel pipes, cable coverings, monofilaments, hollow bodies, injection moulding parts, which can for example also be reinforced with short glass fibre and mineral-filled.

If LC-6 (caprolactam) is polymerized in a monomer casting process in which no de-activator can be added conditional upon the method, the catalyst deactivation is again possible later during re-melting with the addition of an acidically acting compound, such as ethylene acrylic acid copolymer, after which a degradation-resistant PA 6 results, which is suitable for subsequent usual thermoplastic processes, for example as a regranulate from a recycling process.

The subsequent examples serve for further illustration of the invention.

### EXAMPLES

The invention is now intended to be explained in more detail with reference to examples.

For this purpose, the performed tests are summarized in the Tables 1 and 2, Table 1 comprising the substances used—in the respective selected mol ratio to each other—and Table 2 the chosen polymerization conditions and the analysis results.

In the Tables the following mean:

| | |
|---|---|
| S | the solvation medium, and thereby |
| NOP | N-octylpyrrolidone |
| CyPy | N-cyclohexylpyrrolidone |
| DMPU | the cyclic N,N'-dimethylpropylene |
| | urea |
| NMP | N-methylpyrrolidone |

All S-media used are products of the BASF company, Ludwigshafen, Germany.

| | |
|---|---|
| V | the capping agents for the isocyanate |
| | used, the following meanings applying: |
| Ny | Nylostab S-EED, a stabilizer for polyamide |
| | of the Clariant Company (Huningue, |
| | FR) with 2 carboxamide groups in the |
| | molecule |
| MeOH | methyl alcohol |
| LC-6 | caprolactam |
| LC-12 | laurinlactam |
| B | the base used for deprotonation, with |
| NaOMe | sodium methylate as approximately 30% |
| | solution in methanol |
| IC | the isocyanate used, with |
| PIC | phenylisocyanate |
| Cy | cyclohexylisocyanate |
| CPIC | p-chlorophenylisocyanate |
| MTIC | m-tolylisocyanate |

All the isocyanates used are products of the Bayer AG, Leverkusen, Germany.

The molar ratio of the starter materials used is illustrated in the column “mol ratio”.

The column “batch” shows the calculated batch size of the liquid catalyst particles, respectively as sodium salt, without the salvation medium.

The column “Conc” shows the calculated concentration of this particle in mol per kg of catalyst solution.

In Table 2 the following mean:

| | |
|---|---|
| Weight - % FK | the weight proportion of FK which was |
| | added to 100 parts LC-12, |
| PG.N | the mol parts of lactam-12, relative |
| | to 1 mol part FK particles |
| T | the temperature at which polymerization |
| | took place in ° C., |
| t | the polymerization time in min. |
| LC-12, gr | the used quantity of lactam melt for |
| | the polymerization (in grams) |

In the case of the analysis results, the following mean:

| | |
|---|---|
| tᵤ | the time after which the viscosity of |
| | the activated lactam melt rapidly increases. |
| | For this test, the lactam |
| | melt is mixed in an Erlenmeyer flask |
| | with the liquid catalyst, mixing being |
| | effected with a magnetic agitator. tᵤ |
| | is now the time (in seconds) after |
| | which the agitator stops rotating as a |
| | result of the viscosity increase and |
| | is hence a measure of the polymeriza- |
| | tion course, |
| ηᵣₑₗ | the relative solution viscosity of the |
| | polylactam, measured as 0.5% solution |
| | in m-cresol, |
| DSC Max | the melting point maximum (peak) of |
| | the polylactam from the DSC measure- |
| | ment curve, in ° C., |
| Extract | the residual proportion of unconverted |
| | lactam extracted with boiling methanol, |
| | in % by weight. |

From the described possible synthesis pathways for producing the liquid catalysts according to the invention, the following synthesis pathway for the illustrated examples was chosen, there applying as general synthesis rule:

all starter materials must be water-free, and

the process takes place in a dry inert gas, in particular in a dry nitrogen atmosphere,

the polymerization also is implemented then advantageously under inert gas, in particular under nitrogen.

The lactam and if necessary the educts used as V-agents were dissolved in the S-medium at 70-100° C. Then the methanolic sodium methylate solution was added slowly in drops under a vacuum and at 70-120° C. and, after the total NaOMe quantity was added, the temperature was slowly raised while maintaining the vacuum. Precipitate formation occurs thereby generally as an intermediate step, but the precipitate dissolves again with the conversion of the lactam into lactamate. In order to achieve as complete a conversion as possible, agitation took place under a vacuum of approximately 20 torr during approximately 100 minutes at 120° C. and the reaction solution was then cooled, whereby a precipitate being able to form below approximately 70° C. Now the addition of the isocyanate is effected, a precipitate possibly formed upon cooling going spontaneously back into solution and thereby the FK being produced with the main component as illustrated with the general formula I. It is a darkly coloured liquid which is viscous at room temperature and is stable in storage without activity loss over months.

An evaluation of the analysis result shows that the anionic lactam polymerization is always initiated exceptionally rapidly within a few seconds.

All the resulting polymers have a high molecular weight with a low residual content of unconverted lactam and hence also a high melting point suitable for practical application.

Polymerization Tests in Table 3

Corresponding to the formulation of trial number 8, 500 g liquid catalyst were produced in a fairly large apparatus, and thereon the polymerization behaviour of lactam-12 was tested at 180° C. melt temperature, dependent upon the added catalyst, and total polymerization times of 10, 20 and 30 min. Identical to Table 2 there is respectively

(1) the relative solution viscosity,

(2) the melting point maximum (DSC-peak), and

(3) the residual lactam content (extract)

PG.N implies furthermore the calculated average polymerization degree. The numbers 150 to 400 imply thereby that, per active liquid catalyst particle, respectively 150, then 200 etc. particles of lactam-12 were melted. These laboratory tests were begun at PG.N 50 and 100, and it being shown that polymerization proceeds thereby so rapidly that, with a normal mixing technique, as is used for example for tu determination, no homogenous mixing of the catalyst is possible. Hence only the tests from PG.N 150 on were evaluated in the Table.

A comparison of the ηᵣₑₗ values (1) shows that these increase with increasing PG.N according to expectation.

Astonishingly, a high constancy of the ηᵣₑₗ values is however displayed at different times. With (PG.N-dependent) constantly high ηrᵣₑₗ values, the drop in ηᵣₑₗ between 10 and 30 minutes total polymerization time is maximum 7%, relative to the first measured value at 10 min total polymerization time.

Furthermore the results for the lactam conversion (=100% minus extract value) are unexpectedly high.

With polymerization degrees of 150 and 200, which are normal in practice, there results already after 10 minutes polymerization time, a residual lactam content of only approximately 0.20% which subsequently drops to 0.15%.

Even at a very high polymerization degree of PG.N 400, there results already after 20 min polymerization time a residual lactam content of significantly under 1%.

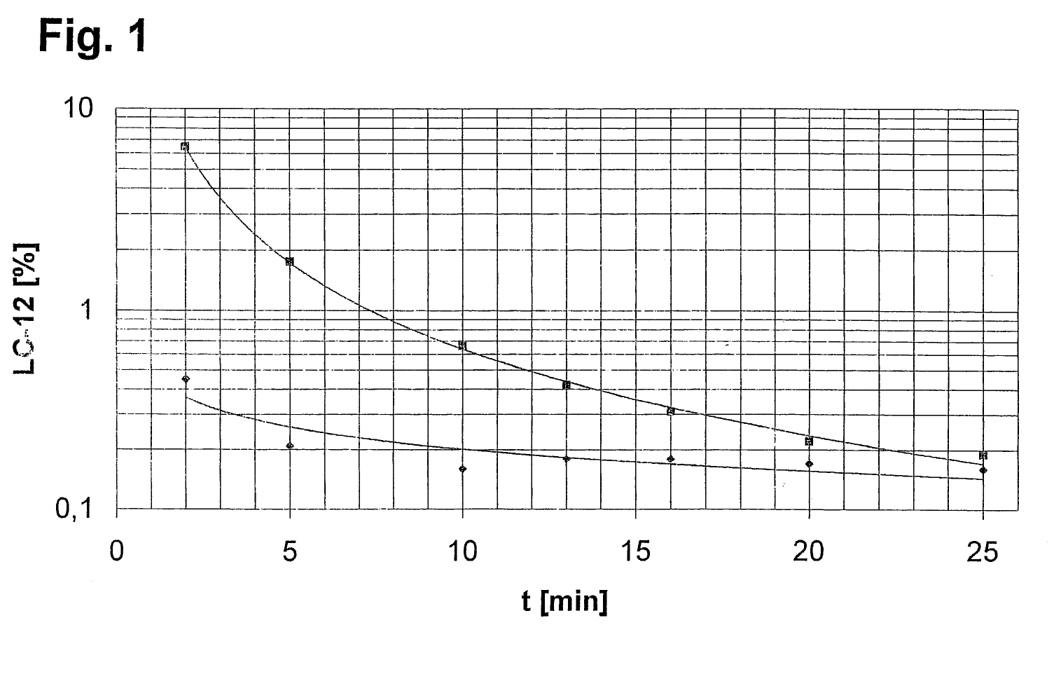

In FIG. 1, the reduction in the LC-12 residual content is illustrated graphically for the polymerization of LC-12 with liquid catalyst, dependent upon the polymerization time in a logarithmic scale (lower curve, ♦). For this purpose, liquid catalyst as was prepared in example (Test No.) 7 was used. This was used in a proportion corresponding to PG.N=200 and the polymerization temperature was 200 ° C. In addition, the polymerization course was compared with the lactam conversion using a normal, lactam-free liquid catalyst of the same basic structural composition in which however, instead of LC-6, methanol was used as capping agent (upper curve, ▪).

The results show impressively that, during the first and decisive minutes of the polymerization course, the monomer conversion in contrast to lactam-free FK is already exceptionally high so that, for example in a continuous polymerization process, 2 to 5 minutes polymerization time suffice already al 200° C. to provide a polylactam which is suitable for application.

Use of the Catalyst According to the Invention for Continuous Polymerization on an Extruder

In order to test whether the FK according to the invention is suitable for the continuous lactam-12 polymerization on a twin-screw extruder, a pilot plant extruder of the firm Werner and Pfleiderer, Stuttgart, of the type ZSK-25 was equipped with a normal compounding screw and provided with a boring in housing 4 for the continuous FK metering.

For carrying out the test, dried lactam-12 in pill form corresponding to a throughput of 12 kg/h was supplied carefully to the extruder feed and melted in zone 1 to 4 at temperature settings of 23, 50, 120 and 220° C. After that, the set temperature was maintained constant at 270° C. The rotation of the extruder screws was respectively 200 rotations per minute.

With special measures

during test 14 to 16 in the middle of the extruder the housing 10 was opened at the top,

during test 15, the meterings were changed such that only the half extruder length was available for the polymerization, and

during test 16, the catalyst quantity was slightly increased.

The analysis results show that the FK according to the invention is exceptionally well suited for continuous lactam polymerization (Table 4).

With a constant lactam feeding of 12 kg/h, which is a high throughput for the chosen ZSK-25, low residual lactam values result, lower than are normal for hydrolytic lactam polymerization, together with high values of the relative solution viscosity.

Test 15 with the polymerization zone shortened to the half length, wherein the residual lactam content remains low, proves that a substantial increase in throughput must be possible. Additionally performed dwell time measurements show that the dwell time in the polymerization zone for test 13, 14 and 16 is 40 to 50 seconds and for test 15 only 25 to 35 seconds.

Opening of an extruder housing for the purpose of an additional degassing possibility does not influence the granulate quality.

This result is in accordance with the lactam conversion curve corresponding to FIG. 1 where, polymerized here at 200° C., the residual lactam content decreases very much more rapidly than when using FK corresponding to the prior art.

It should be taken into account when evaluating the results according to the invention that for example S. K. Ha (previous literature citation) only achieves a LC-12 conversion of 94 to 97% with significantly longer dwell times and thereby operates with throughput yields of only 2 and 4 kg/h.

TABLE 1
synthesis of liquid catalyst

| Test | | | | | | | mol ratio | | | | | | Batch (g) | Conc. |
|---|---|---|---|---|---|---|---|---|---|---|---|---|---|---|
| No. | S | V | LC-6 | LC-12 | B | IC | S:V:LC-6:LC-12:B:IC | | | | | | solid material | Mol/kg |
| 1 | NOP | — | √ | √ | NaOMe | PIC | 4.5 | — | 0.72 | 0.3 | 0.97 | 1 | 25 | 0.85 |
| 2 | NOP | Ny | √ | √ | NaOMe | PIC | 4.3 | 0.3 | 0.42 | 0.3 | 0.97 | 1 | 23 | 0.86 |
| 3 | CyPy | — | √ | | NaOMe | PIC | 4.5 | | 1.02 | | 0.97 | 1 | 25 | 1.00 |
| 4 | DMPU | — | √ | | NaOMe | PIC | 4.5 | | 1.02 | | 0.97 | 1 | 25 | 1.15 |
| 5 | NOP | — | √ | | NaOMe | PIC | 2.0 | | 1.02 | | 0.97 | 1 | 25 | 0.93 |
| | CyPy | | | | | | 2.5 | | 1.02 | | 0.97 | 1 | | |
| 6 | NOP | — | √ | | NaOMe | PIC | 3.0 | | 1.02 | | 0.97 | 1 | 25 | 0.96 |
| | DMPU | | | | | | 1.5 | | | | | | | |
| 7 | NOP | — | √ | | NaOMe | PIC | 4.2 | — | 1.02 | | 0.97 | 1 | 25 | 0.89 |
| 8 | NOP | — | √ | | NaOMe | PIC | 5.0 | — | 0.95 | | 0.95 | 1 | 25 | 0.80 |
| 9 | NOP | — | √ | | NaOMe | Cy | 5.0 | | 1.10 | | 1 | 1 | 20 | 0.79 |
| 10 | NOP | — | √ | | NaOMe | CPIC | 5.0 | | 1.0 | | 1 | 1 | 20 | 0.79 |
| 11 | NOP | — | √ | | NaOMe | MTIC | 5.0 | | 1.0 | | 1 | 1 | 20 | 0.80 |
| 12 | NOP | Ny | — | √ | NaOMe | PIC | 4.0 | 0.60 | — | 0.41 | 0.98 | 1 | 20 | 0.87 |
| 13 | NMP | MeOH | √ | — | NaOMe | PIC | 2.7 | 0.45 | 0.52 | — | 0.95 | 1 | 20 | 1.04 |
| | NOP | | | | | | 2.75 | | | | | | | |
| 14 | NMP | MeOH | √ | — | NaOMe | PIC | 1.8 | 0.30 | 0.67 | — | 0.95 | 1 | 20 | 0.96 |
| | NOP | | | | | | 3.5 | | | | | | | |
| 15 | NMP | MeOH | √ | — | NaOMe | PIC | 0.9 | 0.15 | 0.81 | — | 0.95 | 1 | 20 | 0.88 |
| | NOP | | | | | | 4.25 | | | | | | | |

TABLE 2
polymerization tests with tᵤ time

| | | | | | | Analysis results | | | |
|---|---|---|---|---|---|---|---|---|---|
| Test | Polymerization. conditions | | | | | | | DSC Max | Extract % |
| No. | G-% FK | for PG.N | T, ° C. | t, Min. | LC-12, gr | tᵤ, sec. | ηᵣₑₗ | ° C. | by weight |
| 1 | 2.93 | 200 | 200 | 30 | 50 | 8 | 3.165 | 174.8 | 0.33 |
| 2 | 2.91 | 200 | 200 | 30 | 50 | 5 | 2.200 | 175.6 | 0.15 |
| 3 | 2.51 | 200 | 200 | 30 | 50 | 6 | 3.258 | 174.1 | 0.16 |
| 4 | 2.17 | 200 | 200 | 30 | 50 | 6 | 3.116 | 174.5 | 0.15 |
| 5 | 2.69 | 200 | 200 | 30 | 50 | 4 | 3.452 | 174.3 | 0.15 |
| 6 | 2.62 | 200 | 200 | 30 | 50 | 5 | 3.131 | 174.5 | 0.16 |
| 7 | 2.72 | 200 | 200 | 30 | 50 | 6 | 3.50 | 174.8 | 0.16 |
| 8 | 3.10 | 200 | 200 | 30 | 50 | 12 | 3.40 | 174.0 | 0.20 |
| 9 | 3.15 | 200 | 200 | 30 | 50 | 10 | 4.59 | 174.4 | 0.14 |
| 10 | 3.19 | 200 | 200 | 30 | 50 | 9 | 3.59 | 173.9 | 0.25 |
| 11 | 3.14 | 200 | 200 | 30 | 50 | 17 | 3.41 | 173.9 | 0.57 |
| 12 | 2.88 | 200 | 200 | 30 | 50 | 6 | 2.416 | 176.0 | 0.30 |
| 13 | 2.4 | 200 | 200 | 30 | 50 | 5 | 2.703 | 175.5 | 0.16 |
| 14 | 2.6 | 200 | 200 | 30 | 50 | 5 | 2.894 | 175.2 | 0.15 |
| 15 | 2.84 | 200 | 200 | 30 | 50 | 5 | 3.063 | 175.5 | 0.17 |

TABLE 3

| | Polymerization time (min) | | | | | | | | |
|---|---|---|---|---|---|---|---|---|---|
| | 10 | | | 20 | | | 30 | | |
| PG.N | \mathring{1} | \mathring{2} | \mathring{3} | \mathring{1} | \mathring{2} | \mathring{3} | \mathring{1} | \mathring{2} | \mathring{3EE} |
| 150 | 2.699 | 174.8 | 0.19 | 2.666 | 174.6 | 0.15 | 2.627 | 175.0 | 0.15 |
| 200 | 3.364 | 174.4 | 0.21 | 3.267 | 174.1 | 0.16 | 3.130 | 174.2 | 0.15 |
| 300 | 4.602 | 173.9 | 0.81 | 4.534 | 173.7 | 0.43 | 4.522 | 174.0 | 0.22 |
| 400 | 5.847 | 172.4 | 1.27 | 5.790 | 172.9 | 0.45 | 5.568 | 173.4 | 0.63 |

TABLE 4
Direct polimerization of LC 12 on a twin-screw
extruder with FK from Example (Test No.) 7

| Test No. | 16 | 17 | 18 | 19 |
|---|---|---|---|---|
| Additive FK, % by weight | 2.75 | 2.75 | 2.75 | 2.92 |
| corresponds to PG.N | 200 | 200 | 200 | 190 |
| Analysis | | | | |
| LC-12, % by weight | 0.28 | 0.30 | 0.29 | 0.27 |
| ηᵣₑₗ | 3.03 | 3.15 | 2.89 | 2.88 |

1. Liquid catalyst (FK) for implementation of anionic lactam polymerization, containing a conversion product of a lactam (LC), isocyanate (IC) and a base (B), the conversion product occurring dissolved in a salvation medium (S), characterized in that,
the isocyanate (IC) is selected from phenylisocyanate, substituted phenylisocyanate, cyclohexylisocyanate or mixtures thereof.

2. Liquid catalyst according to claim 1, characterized in that the isocyanate has been used completely or partially in a cyclized form.

3. Liquid catalyst according to claim 1 or 2, characterized in that the conversion product has been obtained with the proviso that for 1 mol (IC), 0.8-1.2 mol (B) and 0.8-1.2 mol (LC) have been used.

4. Liquid catalyst according to at least one of the claims 1 to 3, characterized in that the lactam (LC) has been replaced with up to 49% mol by an additional capping agent (V).

5. Liquid catalyst according to claim 4, characterized in that the conversion product has been obtained with the proviso that for 1 mol (IC), 0.9-1.1 mol (B), 0.49-0.01 mol (V), and 0.51-1.2 mol (LC) have been used.

6. Liquid catalyst according to claim 5, characterized in that the mol ratio is (IC):(B):(V):(LC)=(1):(1.1-0.9):(0.1-0.01):(0.9-1.2)

7. Liquid catalyst according to at least one of the claims 4 to 6, characterized in that the additional capping agent (V) is selected from alcohols with 1-5 C-atoms and carboxamides.

8. Liquid catalyst according to claim 7, characterized in that the additional capping agent (V) is methanol.

9. Liquid catalyst according to claim 7, characterized in that the carboxamide contains additional sterically hindered amino groups with a stabilizing effect.

10. Liquid catalyst according to at least one of the claims 1 to 9, characterized in that the cation of the base (B) is an alkali or alkaline earth metal ion or tetraalkylammonium and the base is selected from alcoholate, amide, hydride or alkyl anion.

11. Liquid catalyst according to claim 10, characterized in that the base (B) is an alkali or alkaline earth alcoholate.

12. Liquid catalyst according to at least one of the claims 1 to 11, characterized in that the solvation medium (S) is an aliphatic, cycloaliphatic or aromatic organic compound which has solvating structural elements which have no acid H-atoms.

13. Liquid catalyst according to claim 12, characterized in that the salvation medium (S) is a polar aprotic compound chosen from the group of etherified polyglycols, liquid phthalic esters, N-alkylated urea compounds, N-alkylated carboxamides or mixtures thereof.

14. Liquid catalyst according to claim 13, characterized in that the urea compound is a tetraalkyl urea containing radicals R on the N with 1-12 C-atoms, chosen in particular from the group tetramethyl urea, tetraethyl urea, tetrabutyl urea or a cyclic structure according to the general formula 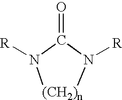
in which R is an alkyl radical with 1-5 C-atoms, in particular a methyl radical and n being 2 or 3.

15. Liquid catalyst according to claim 13, characterized in that the salvation medium (S) is a cyclic 5-7 member N-alkylated carboxamide and the alkyl radical has 1-12 C-atoms, in which radical also heteroatoms may be contained.

16. Liquid catalyst according to claim 13, characterized in that the salvation medium (S) is N-methylpyrrolidone, N-octylpyrrolidone, N-cyclohexylpyrrolidone, N-octylcaprolactam or a mixture thereof.

17. Liquid catalyst according to claim 13, characterized in that the solvation medium (S) is a mixture of urea derivative and acid amide.

18. Liquid catalyst according to at least one of the claims 1 to 17, characterized in that it contains additional additives for the processing and/or use.

19. Liquid catalyst according to at least one of the claims 1 to 18, characterized in that the lactam (LC) is chosen from lactams with 5-13 ring members, in particular caprolactam and laurinlactam or mixtures thereof.

20. Method for producing a liquid catalyst (FK) according to at least one of the claims 1 to 19, characterized in that the conversion product is produced in the salvation medium (S) under inert gas and with moisture exclusion in the temperature range of room temperature to 150° C., wherein low-molecular solvents for the base and neutralization products of the base, in particular low molecular alcohols, being removed if necessary under the action of a vacuum.

21. Method according to claim 20, characterized in that, in a salvation medium (S), the lactam (LC) and if necessary the additional capping agent (V) are converted with the base (B) so that the (LC) and if used (V) occur in deprotonated form and subsequently the isocyanate (IC) or directly an isocyanurate, if necessary dissolved in a solvation medium (S), are added and converted into the liquid catalyst.

22. Method according to claim 20 or 21, characterized in that, in a preliminary method step, the isocyanate (IC) is subjected to a cyclization reaction in a solvation medium (S) into isocyanurate and subsequently, if necessary in a salvation medium (S), lactam (LC) and if necessary an additional capping agent (V), and also a base (B) are added and the reaction mixture is converted into the liquid catalyst.

23. Method according to at least one of the claims 20 to 22, characterized in that lactam (LC) and if necessary an additional capping agent (V) are dissolved in a proportion of salvation medium (S) and converted via the addition of base (B) into the anionic salt form and volatile reaction products and also solvent and salvation medium components which impede polymerization are removed and the isocyanate (IC), possibly in cyclized form, is dissolved separately in a second proportion of solvation medium (S) and the solutions are thereafter combined and converted into the liquid catalyst.

24. Method according to claim 20 or 22, characterized in that the isocyanate (IC) or isocyanurate is added to the lactam (LC) and if used to the additional capping agent (V) and converted and the now capped isocyanate is subsequently deprotonated by means of a base and so converted into the liquid catalyst.

25. Method according to claim 22, 23 or 24, characterized in that the cyclized isocyanate is used in the trimerized form.

26. Polymer granulate which is produced by continuous anionic polymerization of lactam with a liquid catalyst according to at least one of the claims 1 to 19.

27. Polymer granulate according to claim 26, characterized in that lactam-6, lactam-12 or a mixture thereof has been used as lactam.

28. Polymer granulate according to claim 26 or 27, characterized in that the liquid catalyst has been added to the lactam melt in a proportion of 0.3-10% by weight, relative to the lactam quantity.

29. Polymer granulate according to claim 28, characterized in that a liquid catalyst proportion of 0.5-3% by weight has been used.

30. Polymer granulate according to at least one of the claims 26 to 29, characterized in that the polymer granulate has been produced continuously on a twin-screw extruder.

31. Use of the liquid catalyst according to one of the claims 1 or 19 for direct production of granulate or utility objects made of polylactam in a process of the type monomer casting, extrusion, centrifugal moulding, injection moulding, rotational moulding, pultrusion, immersion and spraying methods, the liquid catalyst being added respectively to the lactam melt.
